(19) United States
(12) Patent Application Publication
(10) Pub. No.: US 2020/0347196 A1
(43) Pub. Date: Nov. 5, 2020

(54) HYDROPHILIZATION TREATMENT METHOD OF POLYPROPYLENE RESIN

(71) Applicant: KURITA WATER INDUSTRIES LTD., TOKYO (JP)

(72) Inventors: TATSUO NAGAI, TOKYO (JP); Yuzuki YAMAMOTO, TOKYO (JP)

(73) Assignee: KURITA WATER INDUSTRIES LTD., TOKYO (JP)

(21) Appl. No.: 16/760,030

(22) PCT Filed: Sep. 14, 2018
(86) PCT No.: PCT/JP2018/034105

§ 371 Date: Apr. 28, 2020

(30) Foreign Application Priority Data
Oct. 31, 2017 (JP) 2017-210280

(51) Int. Cl. C08J 7/14; C25B 1/30

(52) U.S. Cl. CPC C08J 7/14; C23C 18/24; C08J 2323/12; C25B 1/30

(57) ABSTRACT

A treatment device 1 includes: a treatment tank 2; an electrolytic cell 6 including diamond electrodes continuous from a pipe 4 including a circulation pump 5; and a pipe 7 supplying from the electrolytic cell 6 to the treatment tank 2. The treatment tank 2 and the electrolytic cell 6 are filled with sulfuric acid having a predetermined concentration; current is applied to the electrolytic cell 6 to electrolyze the sulfuric acid and a persulfuric acid solution S is generated by electrolyzing the sulfuric acid; and the persulfuric acid solution S is supplied to the treatment tank 2 through the pipe 7. Besides, inside the treatment tank 2, a polypropylene resin board 8 which is a treatment target is vertically suspended in a state of being fixed to a fixture 8A, and the polypropylene resin board 8 is treated by the persulfuric acid solution S.

### BACKGROUND OF THE INVENTION

### Technical Field

The present invention relates to a hydrophilization treatment method of polypropylene resin suitably used as plating pre-treatment of polypropylene resin.

### Related Art

Plastic has substituted for metal in a member in which metal is used as a structure material or a component material, taking advantage of light weight, low cost, freedom of shape, ease of mass production and the like. Presently, plastic is widely used not only for decoration but also for exterior or interior components of automobiles, home appliances and the like. At this time, in order to improve rigidity, wear resistance, weather resistance, heat resistance and the like, plating is performed on a plastic surface in many cases.

Because plastic is non-conductive, it is necessary to first form a metal film serving as a conductor on the plastic before plating. The method can be broadly categorized into dry methods such as CVD (chemical vapour deposition) and PVD (physical vapour deposition) and a wet method of electroless nickel plating. Because the dry methods are mostly used for film formation in a vacuum state and are not suitable for application to mass production or large components, the wet method has been adopted so far.

The polypropylene resin is lightweight and has a specific gravity of 0.93-0.96 g/cm³. Besides, the polypropylene resin has good moldability with thermo plasticity and excellent mechanical strength among general-purpose resins and can also be recycled. Therefore, the polypropylene resin is used for food trays, carpets, home electrical appliance components such as TV housings and the like, and automobile components such as bumpers and the like.

A hydrophilization treatment before plating of a plastic molded product made of this polypropylene resin may be a chromic acid treatment, but the chromic acid has weak oxidizing power, and thus the polypropylene resin surface is difficult to be made hydrophilic. In addition, as an environmentally-friendly technology which replaces chromic acid, patent literature 1 describes etching performed with a mixed solution of permanganate and inorganic salt.

Furthermore, patent literature 2 and patent literature 3 disclose a pre-treatment method for electroless plating in which the surface of a plastic molded product is roughened using ozone-dissolved water.

### LITERATURE OF RELATED ART

### Patent Literature

Patent literature 1: Japanese Patent Laid-Open 2008-31513

Patent literature 2: Japanese Patent Laid-Open 2002-121678

Patent literature 3: Japanese Patent Laid-Open 2012-52214

### SUMMARY

### Problems to be Solved

However, in the method of etching with the mixed solution of permanganate and inorganic salt described in patent literature 1, there is a problem that the polypropylene resin is difficult to be made hydrophilic and has poor adhesion to metal. In addition, even in the plating pre-treatment method of a plastic surface described in patent literature 2 and patent literature 3, the polypropylene resin is difficult to be made hydrophilic. In addition, because ozone decomposes at a high rate, ozone water having a high concentration must be manufactured and the high concentration must be maintained. Therefore, there is a problem that not only large-scale equipment is required, unevenness is also likely to occur in treatment due to a local difference in the ozone concentration. Therefore, the polypropylene resin is very difficult to be plated with metal such as chromium or nickel.

The present invention is completed in view of the above problems and has an object to provide a hydrophilization treatment method of polypropylene resin which is used as plating pre-treatment of a chromium- and manganese-free polypropylene resin surface and can form plating sufficiently adhered to the polypropylene resin surface.

### Means to Solve Problems

In order to achieve the above object, the present invention provides a hydrophilization treatment method of polypropylene resin, treating a surface of polypropylene resin by a solution with sulfuric acid electrolyzed therein (Invention 1).

According to the invention (Invention 1), due to a strong oxidizing action of persulfuric acid generated by electrolyzing the sulfuric acid, the polypropylene resin surface is slightly dissolved and roughened and hydrophilic functional groups such as hydroxyl group, carboxyl group and the like are exposed. Therefore, the plating sufficiently adhesive can be obtained by performing plating treatment after the hydrophilization treatment. Moreover, in the specification, the polypropylene resin includes not only a homopolymer of propylene but also a polypropylene resin composition in which other resin components such as polyethylene, polybutadiene and the like are blended with the polypropylene resin in an amount of about 20 wt % or less with respect to a total of 100 wt % of the other resin components and the polypropylene resin, or a copolymer which contains block copolymerized or randomly copolymerized propylene as a main component which is obtained by block or random copolymerization of propylene with other olefins such as ethylene, butadiene and the like in an amount of about 20 wt % or less with respect to a total of 100 wt % of the olefins and the propylene.

In the above invention (Invention 1), a sulfuric acid concentration of the solution is preferably 85-98 wt % (Invention 2).

According to the invention (Invention 2), the degree of the treatment of the polypropylene resin surface can be adjusted by adjusting the sulfuric acid concentration.

In the above inventions (Invention 1 and 2), a temperature of the hydrophilization treatment is preferably 100-130° C. (Invention 3).

According to the invention (Invention 3), decomposition of the persulfuric acid can be suppressed and the polypropylene resin surface can be suitably made hydrophilic.

In the above inventions (Inventions 1-3), a persulfuric acid concentration of the solution is preferably 3 g/L or higher (Invention 4).

According to the invention (invention 4), the polypropylene resin surface can be suitably roughened by the strong oxidizing action of the persulfuric acid to expose the hydrophilic functional groups, and the plating particularly adhesive can be obtained by performing the plating treatment after the hydrophilization treatment.

### Effect

According to the hydrophilization treatment method of polypropylene resin of the present invention, the polypropylene resin surface is dissolved and roughened by the strong oxidizing action of the persulfuric acid, and the hydrophilic functional groups such as hydroxyl group, carboxyl group and the like are exposed. Therefore, the plating sufficiently adhesive can be obtained by performing the plating treatment after the hydrophilization treatment.

### BRIEF DESCRIPTION OF THE DRAWINGS

FIG. 1 is a schematic view showing a treatment device to which a hydrophilization treatment method of polypropylene resin according to an embodiment of the present invention can be applied.

### DESCRIPTION OF THE EMBODIMENTS

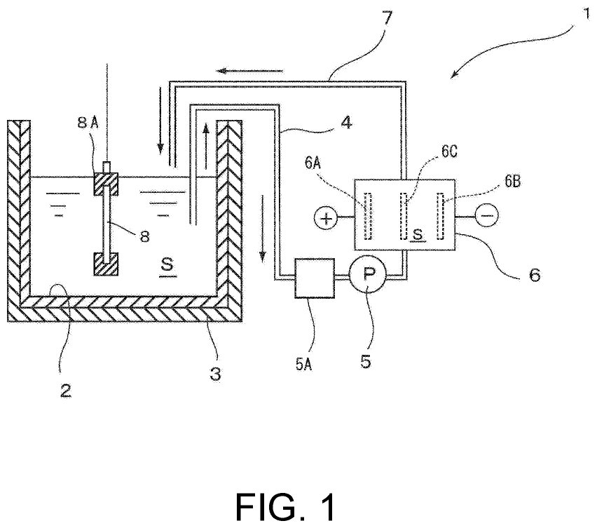

FIG. 1 shows a treatment device suitable for performing a hydrophilization treatment method of polypropylene resin according to an embodiment of the present invention. In FIG. 1, a treatment device 1 includes: a treatment tank 2 in which a constant temperature heater 3 is arranged on an outer circumference; an electrolytic cell 6 continuous from a pipe 4 including a circulation pump 5; and a pipe 7 supplying from the electrolytic cell 6 to the treatment tank 2. Inside the electrolytic cell 6, arranged are an anode 6A and a cathode 6B made of diamond electrodes, and a bipolar electrode 6C disposed between the anode 6A and the cathode 6B. Moreover, in the pipe 4, a heat exchanger 5A for lowering the temperature of circulation solution is preferably arranged before the circulation pump 5. In addition, a stirring part with a liquid circulation function for stirring liquid may be disposed inside the treatment tank 2.

In the treatment device 1, the treatment tank 2 and the electrolytic cell 6 are filled with sulfuric acid having a predetermined concentration in an initial state, and a predetermined current is applied from a DC power supply unit to the anode 6A and the cathode 6B to electrolyze the sulfuric acid. Thereby, a sulfuric acid solution (hereinafter, referred to as a persulfuric acid solution in the specification) S including persulfuric acid (oxidizing agent) such as peroxodisulfuric acid and the like is generated, and the persulfuric acid solution S can be supplied to the treatment tank 2 through the pipe 7. The persulfuric acid solution S is recirculated by the circulation pump 5 from the treatment tank 2 to the electrolytic cell 6 through the pipe 4, and thereby the persulfuric acid solution S is circulated. Besides, inside the treatment tank 2, a polypropylene resin board 8 which is a treatment target is vertically suspended in a state of being fixed to a fixture 8A.

The persulfuric acid solution S preferably has a sulfuric acid concentration of 85-98 wt %, and particularly 90-95 wt %. If the sulfuric acid concentration is lower than 85 wt %, the sulfuric acid concentration of the obtained persulfuric acid solution S is too low, hydrophilic functional groups such as hydroxyl group, carboxyl group and the like cannot be sufficiently exposed on the surface of the polypropylene resin board 8, and an effect of improving adhesion of the plating is not sufficiently obtained. On the other hand, even if the sulfuric acid concentration is higher than 98 wt %, no further improvement in the effect can be obtained and the handling property is also deteriorated, which is not preferable.

Next, the hydrophilization treatment method of polypropylene resin using the treatment device 1 mentioned above is described. First, after sulfuric acid is put into the treatment tank 2 and heated by the constant temperature heater 3, the sulfuric acid is supplied to the electrolytic cell 6 by the circulation pump 5, and a predetermined current is applied from the DC power supply unit to electrolyze the sulfuric acid. Thereby, the persulfuric acid solution S including peroxodisulfuric acid and the like is generated, and the persulfuric acid solution S is supplied to the treatment tank 2 through the pipe 7 and is circulated.

At this time, in order that the temperature of the persulfuric acid solution S is 100-130° C., and particularly 110-120° C., the persulfuric acid solution S is heated by the constant temperature heater 3 as necessary. If the temperature of the persulfuric acid solution S is lower than 100° C., the hydrophilic groups cannot be sufficiently exposed on the surface of the polypropylene resin board 8, and the effect of improving adhesion of the plating is not sufficiently obtained. On the other hand, if the temperature is higher than 120° C., decomposition of the persulfuric acid is accelerated and treatment efficiency is reduced.

In addition, the electrolysis of the sulfuric acid in the electrolytic cell 6 may be performed under conditions that the concentration of the persulfuric acid such as peroxodisulfuric acid and the like generated by the electrolysis is 3 g/L or higher, and particularly 5 g/L. If the persulfuric acid concentration is lower than 3 g/L, the hydrophilic functional groups such as hydroxyl group, carboxyl group and the like cannot be sufficiently exposed on the surface of the polypropylene resin board 8, and the effect of sufficiently improving adhesion of the plating is not obtained. Moreover, an upper limit of the persulfuric acid concentration is not particularly limited, but if the persulfuric acid concentration is higher than 20 g/L, not only the above effect is not improved, but it is also uneconomical, and thus the persulfuric acid concentration may be 20 g/L or lower.

Then, when the persulfuric acid solution S inside the treatment tank 2 reaches the above temperature and persulfuric acid concentration, the surface of the polypropylene resin board 8 is treated by immersing the polypropylene resin board 8 which has been degreased into the treatment tank 2. At this time, in order to suppress air bubbles adhered when the polypropylene resin board 8 is immersed in the persulfuric acid solution S, a wet treatment is preferably applied in advance on the polypropylene resin board 8.

The polypropylene resin board 8 is immersed in the persulfuric acid solution S inside the treatment tank 2 for 30-120 minutes, and thereby the surface of the polypropylene resin board 8 is dissolved and roughened, and the hydrophilic functional groups such as hydroxyl group, carboxyl group and the like are exposed. Accordingly, the adhesion of plating can be improved in the subsequent plating treatment. Moreover, although the persulfuric acid concentration of the persulfuric acid solution S inside the treatment tank 2 gradually decreases, the persulfuric acid solution S is circulated between the electrolytic cell 6 and the treatment tank 2, persulfuric acid is generated in the electrolytic cell 6 and the persulfuric acid concentration of the persulfuric acid solution S is recovered, and thereby the treatment can be continuously performed. At this time, as for the persulfuric acid solution S inside the treatment tank 2, the temperature is high and generation efficiency of the persulfuric acid in the electrolytic cell 6 is low, and thus the temperature is preferably reduced by the heat exchanger 5A.

In the above process, after the functional groups appearing on the resin surface of the polypropylene resin board 8 are activated, neutralization-reduction treatment, conditioning treatment and the like may be performed as necessary. Furthermore, plating is performed after washing with water. In a method for plating treatment, first, electroless nickel plating with autocatalytic properties is deposited, and then plating of electrolytic nickel, electrolytic chromium, or the like is performed. Metal for the electroless plating may be any of nickel, copper and the like, and metal for the electrolytic plating may be any of nickel, chromium, copper, cobalt, alloys thereof and the like. Thereby, a plated product of polypropylene-resin in which the surface of the polypropylene resin board 8 is plated with nickel or the like having good adhesion can be obtained.

In the above, the hydrophilization treatment method of polypropylene resin of the present invention is described based on the embodiment, but the present invention is not limited to the implementation example, and various modifications can be made. For example, the present invention can be applied to continuous treatment instead of batch treatment like the embodiment. In addition, it is needless to say that the polypropylene resin is not limited to being applied to a board as in the embodiment and can be applied to molded articles of various shapes.

### Implementation Example

The present invention is more specifically described using implementation examples and a comparison example below. However, the present invention is not limited to description of the implementation examples and the comparison example. Moreover, in the implementation examples and the comparison example below, the persulfuric acid concentration measurement and adhesion test are performed as follows.

<Persulfuric Acid Concentration Measurement Method>

First, the concentration of the total oxidizing agent included in the treatment solution (the persulfuric acid solution S) is measured by iodine titration. In the iodine titration, potassium iodide (KI) is added to the persulfuric acid solution S to release iodine (I₂), the I₂ is titrated with a standard solution of sodium thiosulfate to obtain the amount of I₂, and the oxidizing agent concentration is obtained from the amount of I₂. Next, the concentration of only the hydrogen peroxide of the persulfuric acid solution S is obtained by potassium permanganate titration, and the persulfuric acid concentration is calculated by subtracting the potassium permanganate titration value from the iodine titration value.

<Plating Adhesion Test>

According to a flow shown in Table 1 below, the plating treatment is performed on the polypropylene resin board 8 which is made hydrophilic with the persulfuric acid solution S, and a sample for the adhesion test is obtained.

TABLE 1

| | | | | Treatment | Treatment |
|---|---|---|---|---|---|
| Process name | Composition | Concentration | | temperature | time |
| Alkali treatment | NaOH | 50 | g/L | 45° C. | 3 minutes |
| Conditioner | CC231*¹ | 10% | | 45° C. | 2 minutes |
| Catalysis | PdCl₂ | 0.3 | g/L | 45° C. | 2 minutes |
| Facilitation | NaH₂PO₂•H₂O | 35 | g/L | 45° C. | 1 minute |
| Electroless Ni—P | SA-98-LF*² | 150 | mL/L | 45° C. | 5 minutes |
| plating | | | | | |
| Heat treatment | — | — | | 150° C. | 30 minutes |
| Copper sulphate | Cu₂SO₄•5H₂O | 250 | g/L | 25° C. | 40 minutes |
| plating*³ | | | | | |

| | | | | |
|---|---|---|---|---|
| Heat treatment | — | — | 150° C. | 30 minutes |

*¹CC231: trade name, manufactured by Rohm & Hass Electronic Material Co., Ltd.
*²SA-98-LF: trade name, manufactured by Okuno. Co., Ltd.
*³Thickness is formed to about 20 μm.

With respect to the obtained samples for the adhesion test, adhesive strength of the plating film is measured as a peel test according to the adhesion test method specified in “decorative electroplating on plastic” in JIS H8630.

### Implementation Example 1

The surface treatment of the polypropylene resin board 8 is performed using the device shown in FIG. 1. Specifications and conditions of the treatment tank are as follows.

<Treatment Tank>

Volume of the treatment tank 2: 40 L
Size of the PPS resin board 8: 500 mm×500 mm×thickness of 5 mm

### <Electrolytic Cell 6 and Electrolysis Conditions for Generating Persulfuric Acid>

Cell volume: 0.5 L
Anode and cathode: diamond electrode (diameter of 150 mm)
Bipolar electrode material: the same as the anode and the cathode
Current density: 50 A/dm²
Liquid circulation rate: 52 L/hr
<Hydrophilization treatment conditions>
Sulfuric acid concentration: 92 wt %
Persulfuric acid concentration: 10 g/L
Treatment temperature: 120° C.
Treatment time: 60 minutes

The polypropylene resin board 8 is immersed in a wet treatment tank with a surfactant therein for 10 minutes. Then, the polypropylene resin board 8 is taken out from the treatment tank 2 and washed with tap water after being immersed in the treatment tank 2 filled with the persulfuric acid solution S for 60 minutes to be made hydrophilic. Subsequently, electroless nickel plating is performed by the process shown in Table 1. Thereafter, copper sulphate plating is finally performed. Then, the adhesion strength of the plating film of the polypropylene resin board 8 plated with copper sulphate is measured. Results are shown in Table 2 along with hydrophilization treatment conditions.

### Implementation Examples 2-7

Except that various settings of the conditions for electrolyzed sulfuric acid treatment are changed as shown in Table 2, chromium plating is performed similarly to Implementation example 1, and adhesion of the plating is evaluated. Results are shown in Table 2 along with hydrophilization treatment conditions.

### Comparison Example 1

Except that a sulfuric acid solution with a sulfuric acid concentration of 92 wt % is used in place of the persulfuric acid solution, chromium plating is performed similarly to Implementation example 1, and adhesion of the plating is evaluated. Results are shown in Table 2 along with treatment conditions.

TABLE 2

| | Sulfuric acid | Treatment | Persulfuric acid | Treatment | Adhesion |
|---|---|---|---|---|---|
| | concentration | temperature | concentration | time | strength |
| Example No. | (wt %) | (° C.) | (g/L) | (minute) | (kN/m) |
| Implementation | 92 | 120 | 10 | 60 | 0.9 |
| example 1 | | | | | |
| Implementation | 85 | 120 | 5 | 120 | 0.8 |
| example 2 | | | | | |
| Implementation | 95 | 100 | 3 | 120 | 0.9 |
| example 3 | | | | | |
| Implementation | 92 | 80 | 5 | 120 | 0.6 |
| example 4 | | | | | |
| Implementation | 75 | 120 | 10 | 60 | 0.4 |
| example 5 | | | | | |
| Implementation | 90 | 110 | 10 | 20 | 0.5 |
| example 6 | | | | | |
| Implementation | 85 | 120 | 2 | 60 | 0.5 |
| example 7 | | | | | |
| Comparison | 92 | 120 | 0 | 120 | 0.3 |
| example 1 | | | | | |

As is clear from Table 2, according to the hydrophilization treatment method of polypropylene resin of Implementation examples 1-7, by performing plating on the polypropylene resin board 8 after treatment, the adhesion strength of 0.4 kN/m or greater is obtained. Particularly, in Implementation examples 1-3 in which the treatment is performed at a treatment temperature of 100° C. or higher and a persulfuric acid concentration of 3 g/L or higher for a sufficient time of, for example, 60 minutes or longer, the adhesion strength of 0.8 kN/m or greater is obtained. On the other hand, in Comparison example 1 in which the treatment is performed with sulfuric acid having a concentration of 92 wt % and not including persulfuric acid, even if plating is performed on the polypropylene resin board 8 after the treatment, the adhesion strength is as low as 0.3 kN/m.

### REFERENCE SIGNS LIST

1 treatment device
2 treatment tank
3 constant temperature heater
4 pipe
5 circulation pump
5A heat exchanger
6 electrolytic cell
6A anode
6B cathode
6C bipolar electrode
7 pipe
8 polypropylene resin board
S persulfuric acid solution

1. A hydrophilization treatment method of polypropylene resin, treating a surface of polypropylene resin by a solution with sulfuric acid electrolyzed therein.

2. The hydrophilization treatment method of polypropylene resin according to claim 1, wherein a sulfuric acid concentration of the solution is 85-98 wt %.

3. The hydrophilization treatment method of polypropylene resin according to claim 1, wherein a temperature of the hydrophilization treatment is 100-130° C.

4. The hydrophilization treatment method of polypropylene resin according to claim 1, wherein a persulfuric acid concentration of the solution is 3 g/L or higher.
